(19) United States
(12) Patent Application Publication
(10) Pub. No.: US 2010/0182573 A1
(43) Pub. Date: Jul. 22, 2010

(54) ILLUMINATING DEVICE AND PROJECTION DISPLAY DEVICE

(75) Inventors: Yusuke ITOH, Toyonaka City (JP); Takashi IKEDA, Higashi Osaka City (JP); Takahisa ANDO, Ikoma City (JP); Nobuyuki KONDOU, Moriguchi City (JP); Kiyoko TSUJI, Daito City (JP)

Correspondence Address: MOTS LAW, PLLC, 1629 K STREET N.W., SUITE 602, WASHINGTON, DC, 20006-1635, US

(73) Assignee: SANYO Electric Co., Ltd., Moriguchi City (JP)

(21) Appl. No.: 12/691,119

(22) Filed: Jan. 21, 2010

(30) Foreign Application Priority Data
Jan. 22, 2009 (JP) 2009-012295

(51) Int. Cl. G03B 21/20; G02B 6/04; G03B 21/16

(52) U.S. Cl. 353/30; 362/554

(57) ABSTRACT

An illuminating device includes a plurality of light source portions having a light source and condenser optics for condensing light from the light source, a plurality of optical fibers each connected to a corresponding one of the light source portions and into which the light from the corresponding condenser optics is incident, and a bundling portion for bundling the plurality of optical fibers. The plurality of light source portions are arranged on a plane approximately parallel to a bundling-central axis of the bundling portion, and the farther the light source portion is arranged from the bundling portion, the more the optical axis of the condenser optics is tilted toward the bundling portion from a direction vertical to the plane.

This application claims priority under 35 U.S.C. Section 119 of Japanese Patent Application No. 2009-012295 filed on Jan. 22, 2009, entitled “ILLUMINATING DEVICE AND PROJECTION DISPLAY DEVICE.” The disclosure of the above application is incorporated herein by reference.

### BACKGROUND OF THE INVENTION

1. Field of the Invention

The present invention relates to an illuminating device and projection display device, and especially, is suitable for the illuminating device and projection display device to realize high luminance by using a plurality of light sources.

2. Description of the Related Art

Conventionally, there has been known a projection display device, that projects the modulating light from a light source based on an image signal (hereinafter, referred to as an “image light”), onto a screen. In the projection display device of this type, as the size of a screen has been enlarged in recent years, there is an increasing demand for high luminance of image light. Accordingly, there is a demand for high luminance of illuminating light in an illuminating device for in this type of projection display device.

Then, to realize high luminance of illumination light, the illuminating device applied the arrangement, that the light from a plurality of light sources is coupled by optical fibers and those optical fibers is bundled.

The optical fibers are composed of a core in the center and cladding surrounding the core. The light entered from an incident surface, is propagated through the core by total reflection.

Glass material such as silicon (Si) is used for the core because of the transmittance of light, etc. As the diameter of the core is sufficiently small for the length of the optical fiber, even though it is made from glass material, the optical fiber can be bent into a certain radius. However, if the core is bent so as to have a radius smaller than a prescribed radius, the core is destroyed and the light might leak out from the destroyed section. In this case, it is not able to obtain enough light guiding efficiency as an optical fiber. It is noted that, the smallest radius in the case the destruction of the core doesn't cause, is called a minimum bend radius.

Therefore, in the illuminating device using the optical fibers, it is necessary to consider new arrangement of a bundling portion of bundled optical fibers and the plurality of the light sources, in order that the optical fibers will not be bent under the minimum bend radius.

Specifically, as the illuminating device becomes smaller, the smaller arrangement space of the bundling portion and the light sources makes the radiuses of the optical fibers smaller On the contrary, if the illuminating device is made bigger to make the radiuses of the optical fibers bigger, it may cause the problem that the projection display device becomes larger.

### SUMMARY OF THE INVENTION

The first aspect of the present invention is that the illuminating device includes: a plurality of light source portions having a light source and a condenser optics condensing light from the light source; a plurality of optical fibers each connected to a corresponding one of the light source portions and into which the light from the corresponding condenser optics is incident; and a bundling portion bundles the plurality of optical fibers. The plurality of light source portions are arranged on a plane approximately parallel to a bundling-central axis of the bundling portion, and the farther the light source portion is arranged from the bundling portion, the more the optical axis of the condenser optics is tilted toward the bundling portion from a direction vertical to the plane.

According to the illuminating device relating to the first aspect, even when a distance between the bundling portion and the plane where the light source portions are arranged is shortened, the optical fibers from each light source portion can be guided to the bundling portion drawing a slow curve.

The second aspect of the present invention is that the illuminating device includes: a plurality of light source portions having a light source and condenser optics condensing light from the light source; a plurality of optical fibers each connected to a corresponding one of the light source portions and into which the light from the corresponding condenser optics is incident; and a bundling portion bundles the plurality of optical fibers. The plurality of light source portions are arranged on a plane approximately vertical to a bundling-central axis of the bundling portion, and the farther the light source portion is arranged from the bundling-central axis of the bundling portion, the more the optical axis of the condenser optics is tilted toward the bundling portion from the direction vertical to the plane.

According to the illuminating device relating to the second aspect, even when a distance between the bundling portion and the plane where the light source portions are arranged is shortened, the optical fibers from each light source portion can be guided to the bundling portion drawing a slow curve.

The third aspect of the present invention is that the projection display device includes: an illuminating device; a light modulating portion for modulating the light emitted from the illuminating device; and projection optics for projecting the light modulated by the light modulating portion onto a screen.

The illuminating device includes: the plurality of light source portions having the light source and condenser optics for condensing the light form the light source; the plurality of optical fibers each connected to a corresponding one of the light source portions and into which the light from the corresponding condenser optics is incident; and the bundling portion bundles the plurality of optical fibers. The plurality of light source portions are arranged on a plane approximately parallel to a bundling-central axis of the bundling portion, and the farther the light source portion is arranged from the bundling portion, the more the optical axis of the condenser optics is tilted toward the bundling portion from a direction vertical to the plane.

According to the projection display device relating to the third aspect, even when a distance between the bundling portion and the plane where the light source portions are arranged is shortened, the optical fiber from each light source portion can be guided to the bundling portion drawing a slow curve.

### BRIEF DESCRIPTION OF THE DRAWINGS

The foregoing and other objects and novel features of the present invention will become more apparent upon reading the following detailed description of the embodiment along with the accompanying drawings.

FIGS. 1A and 1B are drawings showing an arrangement method of light source portion in an illuminating device related to the first embodiment.

FIG. 2 is a drawing showing an arrangement of the light source portion with a heat transfer device is installed as in the first embodiment.

FIG. 3 is a drawing showing a holding structure of the light source portion as in the first embodiment.

FIGS. 4A and 4B are drawings showing arrangements of an illuminating device related to the second embodiment.

FIGS. 5A and 5B are drawings showing arrangements of a plurality of the light sources in directions of an X-axis and Y-axis as in the first embodiment.

FIGS. 6A and 6B are drawings showing other arrangements of the heat transfer member for this invention.

FIGS. 7A, 7B and 7C are drawings showing other arrangements and other holding structures of the light sources for this invention.

FIG. 8 is a drawing showing an optical system of a projection display device with the illuminating device of the first embodiment.

FIG. 9 is a drawing showing the optical system of other projection display device with the illuminating device of the first embodiment.

The drawings are provided mainly for describing the present invention, and do not limit the scope of the present invention.

### DESCRIPTION OF THE PREFERRED EMBODIMENTS

In the following, embodiments of the present invention are described referring to the drawings.

### First Embodiment of an Illuminating Device

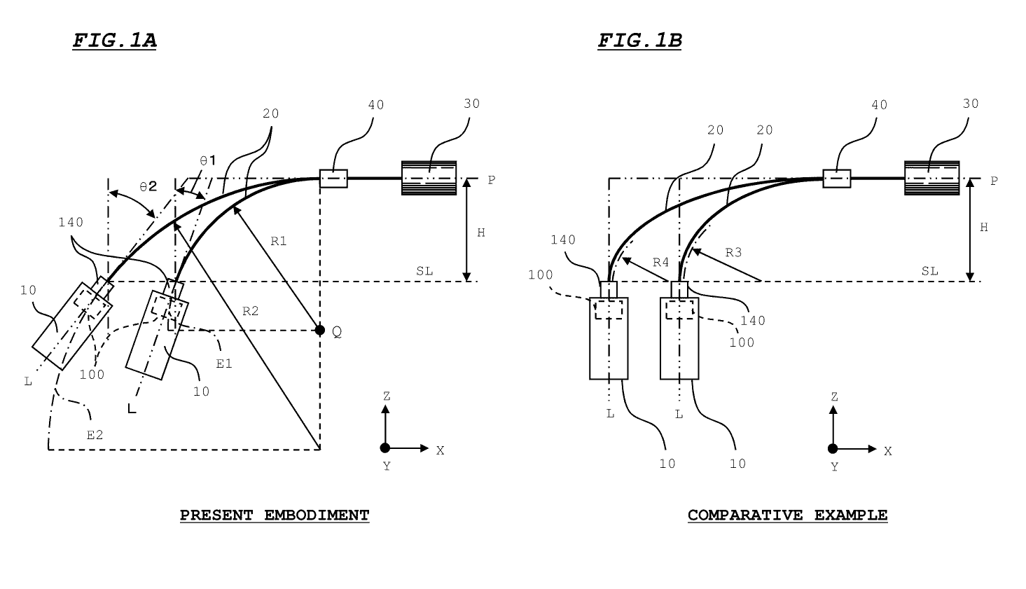

FIGS. 1A and 1B are drawing showing an arrangement of a light source 10 in an illuminating device according to the first embodiment. FIG. 1A shows an arrangement of light source 10 of the present embodiment, and FIG. 1B shows the normal arrangement of the light source portions 10 as a comparative example.

As shown in FIG. 1A, an illuminating device includes a plurality of light sources 10, a plurality of optical fibers 20 provided for each light source portion 10, a bundle 30 for bundling exit ends of the plurality of optical fibers 20, and a supporting portion 40 which bundles the plurality of optical fibers 20 before the bundle 30.

The light source portions 10 include the laser light sources 100. The light irradiated from the laser light sources 100 is guided to incident ends of the optical fibers 20 at a coupling portion 140. Inside of the coupling portions 140, the condenser optics for condensing the light to the incident surfaces of the optical fibers 20 are arranged. The incident ends of the optical fibers 20 are connected to the coupling portion 140 so as to align optical axes L of the condenser optics with optical axes of the optical fibers 20.

The plurality of light source portions 10 are arranged in the X-axis direction. In FIG. 1A, only 2 of the light source portion are illustrated. For the sake of convenience, the following explanation is focused on these two light source portions 10.

The optical fiber 20 is composed of a core in the center and cladding surrounding the core. The light entered to the core from laser light source portion is propagated through the core by total reflection. The exit ends of optical fibers 20 are bundled by the bundle 30.

The bundle 30 has a cylindrical shape and is arranged at a position away from the position of the light source portions 10 in X-axis direction and Z-axis direction. The central axis P of the bundling is parallel to the X-axis direction. Therefore, the light from laser light source portions is irradiated in the X-axis direction from the bundle 30, that is, the exit ends of the optical fibers 20.

A supporting portion 40 is arranged at a position before the bundle 30. The optical fibers 20 are supported by the supporting portion 40 beforehand, so that the exit ends are inserted into the bundle 30 straight along the X-axis direction. The supporting portion 40 is arranged so as to its center axis aligns with the center axis P of the bundle 30.

Then, the two light source portions 10 aligned in the X-axis direction are arranged to have an optical axis L of its condenser optics to tilt toward the bundle 30 with respect to the Z-axis direction. The farther the light source portion 10 is from the bundle 30 in the X-axis direction, the bigger the tilt angles θ1 and θ2 become. It is noted that, henceforth among the two light source portions 10 illustrated in FIG. 1A, the light source portion 10 closer to the bundle 30 is referred to as the “leading light source portion 10,” and the light source portion 10 farther from the bundle 30 is referred to as “following light source portion 10.”

The arrangement position of these leading and following light source portions 10 and tilt angles θ1 and θ2 are decided as follows.

As shown in FIG. 1A, first, an arc E1 having predetermined curvature radius R1 is drawn imaginarily from the position of the central axis P of the support portion 40 in a plane parallel to the X-Z plane. The curvature radius R1 is considered bigger than the above mentioned minimum bend radius of the optical fibers 20. Next, a datum line SL parallel to the X-axis direction is set imaginarily at a position away from the central axis P for a predetermined distance H shorter than the distance from the central axis P to the center Q of the arc E1. The leading light source portion 10 is arranged, so that its tip (the tip of the coupling portion 140) locates at an intersection of the arc E1 and datum line SL. The tilt angle θ1 of the leading light source portion 10 is set, so that its optical axis L is aligned with a tangential line of the arc E1 at the intersection of the arc E1 and datum line SL.

Similarly, an arc E2 having predetermined curvature radius R2 (R2>R1) is drawn imaginarily from the position of the central axis P of the support portion 40 in the plane parallel to the X-Z plane. The following light source portion 10 is arranged, so that its tip locates at an intersection of the arc E2 and datum line SL. The θ2 of the following light source portion 10 is set, so that its optical axis L1 is aligned the tangential line of the arc E2 at the intersection of the arc E2 and datum line SL.

According to the above arrangement, the optical fiber 20 coming out of the leading light source portion 10 is guided to the support portion 40 so as to almost follow a track of the arc E1 on the X-Z plane. Also, the optical fiber 20 coming out of the following light source portion 10 is guided to the support portion 40 so as to almost follow a track of the arc E2 on the X-Z plane.

Tilt angles and arrangements of light source portions other than these two light source portions 10 (not illustrated in FIG. 1) are also set similar to the above.

Therefore, according to the present embodiment, even when the illuminating device is configured compactly as the distance between the bundle 30 and the light source portions10 in the Z-axis direction to be short, it is possible to prevent that the curvature radius of the optical fibers 20 becomes smaller than the minimum bend radius. Thus, the illuminating device can be miniaturized while preventing damage of the optical fibers 20.

It is noted that, as shown in a normal arrangement example of FIG. 1B, when the leading and following light source portions 10 are arranged at the same position as in the embodiment and their optical axes L are both paralleled with the Z-axis direction, the optical fibers 20 may have curvature radii R3 and R4 smaller than the ones in the embodiment. For this reason, when a curvature radius bigger than the minimum bend radius is tried to be maintained, the distance between the bundle 30 and light source portions 10 in the Z-axis direction needs to be longer, so the size in Z-axis direction will be bigger than the present embodiment.

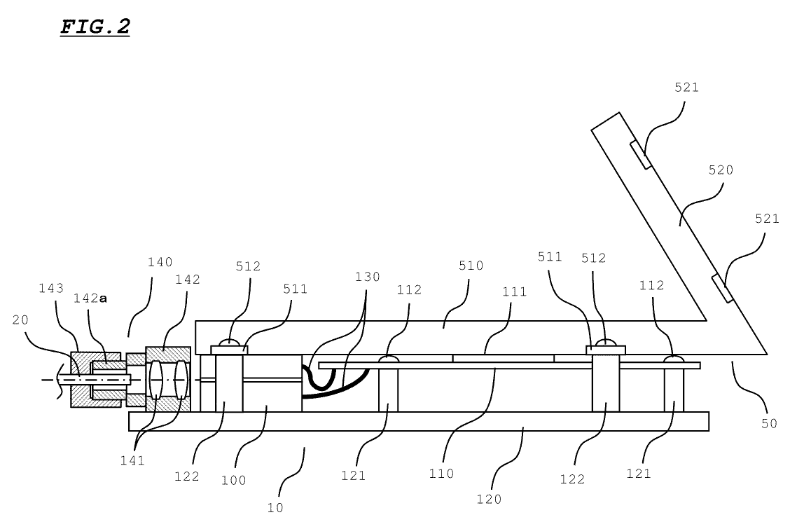

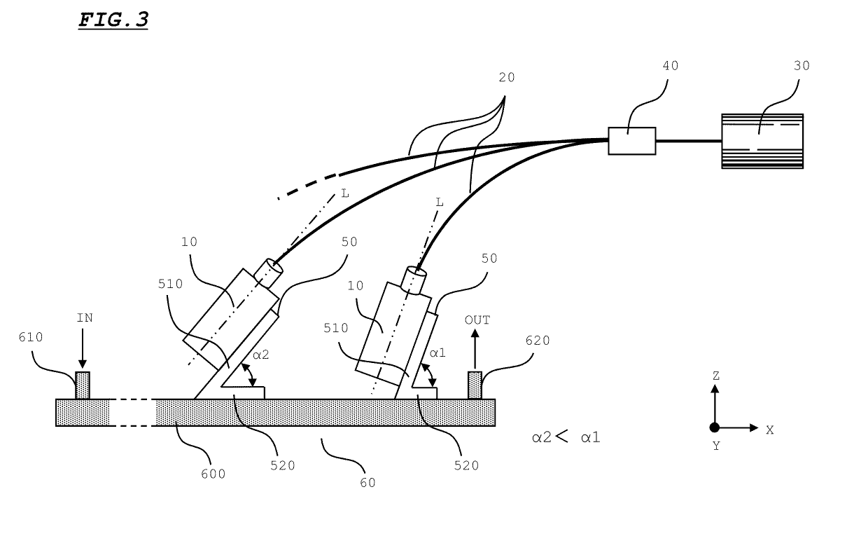

FIG. 2 is a drawing showing an arrangement of the light source portion with a heat transfer member 50 is installed. Also, FIG. 3 is a drawing showing a holding structure of the light source portion 10. Hereafter, referring to FIGS. 2 and 3, a concrete holding structure of the light source portion 10 is explained.

As shown in FIG. 2, a light source portion 10 includes a laser light source 100; a driving circuit 110, a holding plate 120; an electric line 130, and a coupling portion 140. It is noted that, the composition of the laser light source 100 and the coupling portion 140 corresponds to the “light source portion” of the present invention.

The laser light source 100 is, for example, composed of a semiconductor laser. The driving circuit 110 is composed by arranging a driving circuit to drive the laser light source 100 on a substrate, and among electric components installed in the driving circuit, a component 111 which generates heat high when it is driven (hereinafter, referred to as a “heat generating component”) is included.

The laser light source 100 and driving circuit 110 are installed on the same holding plate 120. The laser light source 100 is fixed on the top surface of the holding plate 120 directly with a screw, etc. On the other hand, the driving circuit 110 is fastened at a mounting boss 121 formed on the holding plate 120 with a screw 112. It is preferable that a height of the mounting boss 121 is set so that the heat generating component 111 of the driving circuit 110 is located at the same height position with the laser light sources 100.

A driving signal from the driving circuit 110 is provided to the laser light sources 100 via two electric lines 130. A FPC (Flexible Printed Circuit) with the two electric lines 130 may be used to provide the driving signal from the driving circuit 110.

The coupling portion 140 is further installed on the holding plate 120. The coupling portion 140, as mentioned above, connects the optical fiber 20 to the light source portion 10 and condenses the light emitted from the laser light source 100 on the incident surface of the optical fiber 20.

The coupling portion 140 includes two condensing lenses 141 which construct the condenser optics, a lens holding portion 142 which holds the lenses 141, and a fiber holding portion 143 which fixes the incident ends of the optical fiber 20.

A loading slot part 142a having cylindrical shape is formed at the tip of the lens holding portion 142. The fiber holding portion 143 to which the incident ends of the optical fiber 20 is connected is mounted on the loading slot part 142a.

The fiber holding portion 143 has a shape of a cap, and a female screw portion is formed on its inner circumference wall. On the other hand, a male screw portion is formed on the outer circumference of the loading slot part 142a. As such, the fiber holding portion 143 is fixed on the loading slot part 142a with a screw method. It is noted that, in the state of the fiber holding portion 143 being mounted on the lens holding portion 142, the optical axis of the optical fiber 20 aligns with the optical axis L of the condenser optics.

A heat transfer member 50 is mounted on the light source portion 10. The heat transfer member 50 is made of materials with high heat transfer rate such as copper, aluminum, etc., and is arranged with an endothermic portion 510 which is for absorbing heat from the light source portion 10 and a radiator portion 520 which is for radiating heat to a later mentioned radiator member. Between the endothermic portion 510 and the radiator portion 520, the heat transfer member 50 is bent like a letter L.

The endothermic portion 510 of the heat transfer member 50 is mounted on the holding plate 120 sticking to the laser light source 100 and radiation portion 110. That is, a flange portion 511 is provided on the side of the endothermic portion 510, and the flange portion 511 is fastened by a screw 512 at the mounting boss 122 on the holding plate 120. The radiation portion 520 is provided with a flange portion 521 to mount the heat transfer member 50 on the radiation member 60.

Each light source portion 10 is mounted on a radiation member 60 through the corresponding heat transfer members 50 respectively as shown in FIG. 3.

The radiation member 60 is arranged in the illuminating device so as to be paralleled with the X-Y plane. The radiation member 60 includes a heat exchanging portion 600 extending in X-axis direction, and a flow inlet 610 and flow outlet 620 being formed respectively at both ends of the heat exchanging portion 600. A flow channel is formed with a predetermined pattern inside the heat exchanging portion 600. A cooling liquid drawn through the flow inlet 610 is drawn out through the flow outlet 620 via the flow channel in the heat exchanging portion 600. Thus, the heat exchanging portion 600 is cooled by the cooling liquid.

A bending angle α1 between the endothermic portion 510 and the radiation portion 520 of the heat transfer member 50 on which the leading light source portion 10 is mounted is set to have a tilt angle of the optical axis L of the light source portion 10 as a tilt angle θ1 explained at FIG. 1. Besides, a bending angle α2 of the heat transfer member 50 on which the following light source portion 10 is mounted is set to have a tilt angle of the optical axis L of the light source portion 10 as a tilt angle θ2 explained at FIG. 1.

The leading and following light source portions 10 are arranged having tilt angles θ1 and θ2 respectively with the heat transfer members 50 and the radiation members 60. Also, heat generated at the laser light source 100 and the heat generating component 111 of each light source portion 10 is transferred to the radiation member 60 through the heat transfer member 50, and the heat is radiated at the radiation member 60. For that, the laser light source 100 and the heat generating component 111 are cooled.

Light source portions other than the leading and following light source portions 10 (not illustrated in FIG. 3) are also, similar to the above, mounted on the radiation members 60 through the corresponding heat transfer members 50. The bending angles of the heat transfer members 50 corresponding to these light source portions 10 are also, similar to the above, set according to the tilt angle of the optical axis L of the light source portions 10.

As such, in this embodiment, the arrangement can be simplified since the cooling structure composed of the heat transfer members 50 and radiation members 60 also serves as the holding structure which maintains the light source portions 10 at the tilt angles of θ1 and θ2.

### Second Embodiment of Illuminating Device

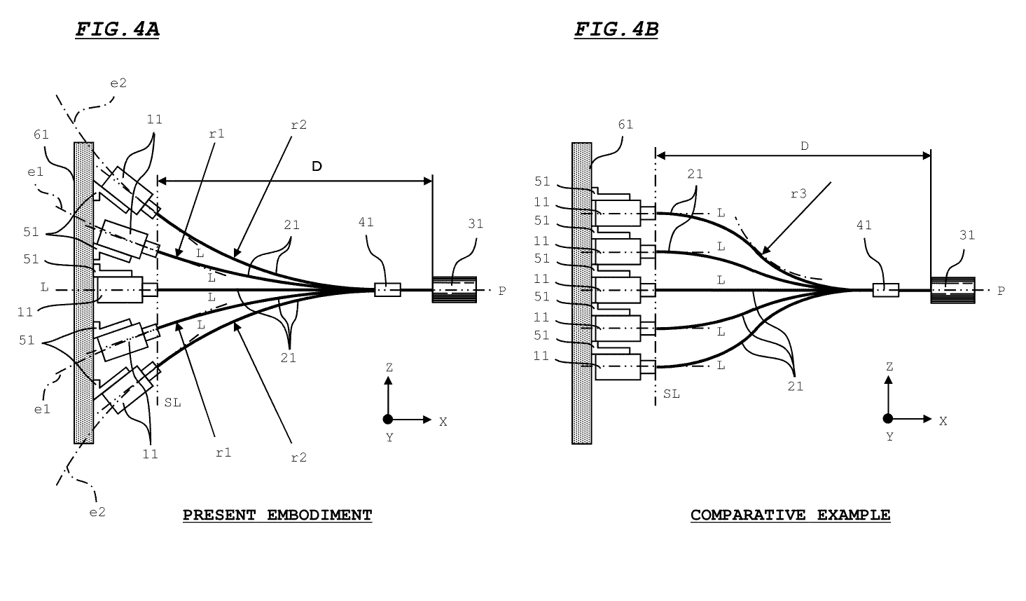

FIGS. 4A and 4B are drawing showing arrangements of an illuminating device related to the second embodiment. FIG. 4A shows an arrangement of the light source portions 11 of this embodiment, and FIG. 4B shows the normal arrangement of the light source portion 11 as a comparative example.

As shown in FIG. 4A, an illuminating device includes a plurality of light source portions11, a plurality of optical fibers 21 provided for each light source portion 11, a bundle 31 bundling exit ends of the plurality of optical fibers 21, and a supporting portion 41 which bundles and holds the plurality of optical fibers 21 at a position before the bundle 31.

The arrangement of the light source portions 11 is the same as the arrangement of the light source portions 10 of the first embodiment, and the coupling arrangement of the optical fibers 21 are also the same as the coupling arrangement shown in the first embodiment (FIG. 2). In addition, the arrangements of the bundle 31 and supporting portion 41 are the same as the arrangement of bundle 30 and supporting portion 41 of the first embodiment.

The illuminating device includes 5 light source portions 11 aligned in a Z-axis direction. A position of the central light source portion 11 among these 5 light source portions 11 agree with a central axis P in the Z-axis direction. Then, the central light source 11 is arranged so that the optical axis L1 of its condenser optics is parallel with the X-axis direction, that is, the central axis P.

On the other hand, the light source portions 11 other than the central light source 11 are respectively arranged to have the optical axis L of their condenser optics to tilt toward the support portion 41 with respect to the X-axis direction. The farther the light source 11 is from the central axis of the support portion 41 (the central axis P of the bundle 31), the bigger the tilt angle becomes. It is noted that, hereinafter, among the four light source portions 11 other than the central light source portion 11, two light source portions closer to the central light source portion 11 are referred to as “the inside light source portion 11,” and two light source portions farther from the central light source portion 11 are referred to as “the outside light source portion 11.”

As shown in FIG. 4A, an arc e1 having a curvature radius r1 bigger than the minimum bend radius of the optical fiber 21 is drawn imaginarily from the position of the central axis P of an entrance of the support portion 41, and a datum line SL parallel with the Z-axis direction is drawn imaginarily at a position away from the bundle 31 for a predetermined distance D in the X-axis direction. The inside light source portions 11 are arranged, so that their tips locate at an intersection of the arc e1 and datum line SL, and tilted, so that their optical axes L agree with a tangential line of the arc e1 at the intersection of the arc e1 and datum line SL.

Similarly, an arc e2 having a curvature radius r2 (r2<r1) bigger than the minimum bend radius of the optical fibers 21 is drawn imaginarily from the support portion 41. The outside light source portions 11 are arranged, so that their tips locate at an intersection of the arc e2 and datum line SL, and tilted, so that their optical axes L agree with a tangential line of the arc e2 at the intersection of the arc e2 and datum line SL.

As such, the optical fibers 21 coming out of the inside light source portion 11 is guided to the support portion 41 so as to draw a track of the arc e1. Also, the optical fibers 21 coming out of the outside light source portion 11 is guided to the support portion 41 so as to draw a track of the arc e2.

Each light source portion 11 is, similar to the first embodiment, mounted on a radiation member 61 through each corresponding heat transfer member 51. The radiation member 61 is arranged as parallel with the Y-Z plane in the illuminating device.

The structure of the heat transfer members 51 is the same as the structure of the heat transfer members 50 of the first embodiment, and their bending angles depend on the tilt of the light source portions 11. Also, the structure of the radiation members 61 is the same as the structure of the radiation members 60 of the first embodiment.

According to the present embodiment, even when the illuminating device is arranged compactly as the distance D between the bundle 31 and the light source portion 11 in the X-axis direction is short, it is possible to prevent that the curvature radius of the optical fiber 21 becomes smaller than the minimum bend radius. Thus, the illuminating device can be miniaturized while preventing damage of the optical fiber 21.

It is noted that, as shown in a comparative example of FIG. 4B, when the inside and outside light source portions 11 are arranged at the same position as in the embodiment and their optical axes L are all paralleled with the X-axis direction, the optical fiber 21 would have curvature radii (for example, curvature radius r3 illustrated) smaller than the ones in the embodiment. For this reason, when a curvature radius bigger than the minimum bend radius is tried to be maintained, the distance between the bundle 30 and light source portion 10 in the X-axis direction needs to be long, so the size in X-axis direction will be bigger than the present embodiment. Thus, according to the present embodiment, compared with a comparative example of FIG. 4B, the distance D between the bundle 31 and light source portions 11 can be shorter.

### Modification of the Illuminating Device

In the first embodiment above, an arrangement where a plurality of light source portions are aligned only in an X-axis direction is illustrated, however the cluster of the light source portions 10 aligned in the X-axis direction like the above can also be arranged with a plurality of lines of the clusters in the Y-axis direction.

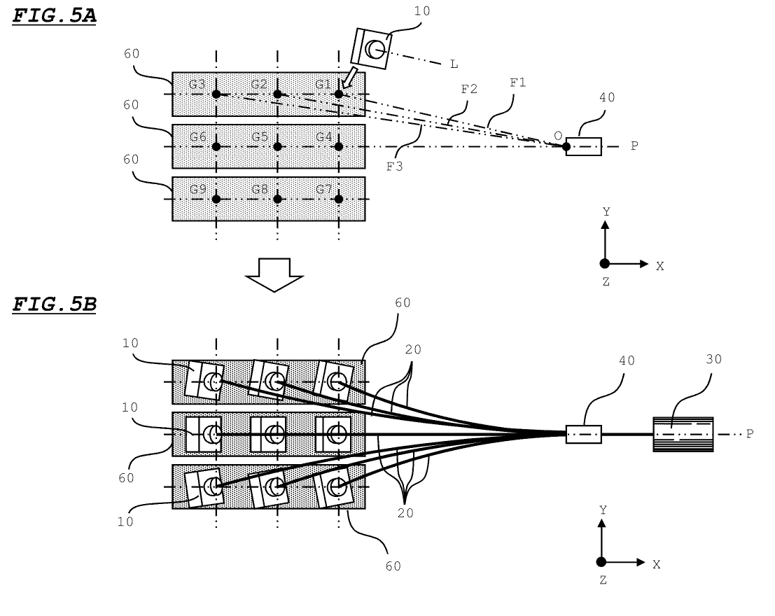

FIGS. 5A and 5B are drawings showing arrangements of a plurality of the light source portions in directions of an X-axis and Y-axis. These figures are plane views seen from the Z-axis direction of the illuminating device.

In this modification, 3 light source portions 10 are arranged in the X-axis direction and 3 rows of 3 light source portions 10 are arranged in the Y-axis direction. As shown in FIG. 5A, in this modification, each arrangement position (the tip of the light source portion 10, for example, G1-G9 of FIG. 5A) of the light source portions 10 mounted on the radiation member 60 is set. Then, arcs (for example, F1, F2, F3 and so on) similar to the arcs E1 and E2 shown in FIG. 1A are drawn imaginarily from the entrance center O of the support portion 40 as the arcs pass through each arrangement positions.

The light source portions 10 are arranged to tile their optical axes L from the Z-axis direction to the X-Y plane direction so as to be paralleled with the tangential lines of corresponding arcs at corresponding arrangement positions.

With this arrangement, as shown in FIG. 5B, the optical axis L of three light source portions 10 of the center row is paralleled with the X-axis direction when seen from the Y-axis direction. Also, as shown in FIG. 5B, the optical axes of 6 light source portions 10, three light source portions 10 each on both outside rows, are tilted somewhat to Y-axis direction from X-axis direction when seen from Y-axis direction.

According to the above arrangement, the optical fibers 20 coming out of all the light source portions 10 arranged in a form of matrix both in the X-axis and Y-axis directions are guided to the support portion 40 as they draw tracks of gentle arcs when seen from the Y-axis direction, similar to the explanation by referring to the above FIGS. 1A, B, 2 and 3.

Therefore, since the optical fibers 20 can be guided from the light source portions 10 to the support portion 40 with smooth arcs, the curvature radius of the optical fibers 20 hardly becomes smaller than the minimum bend radius.

### Modification of Heat Transfer Members

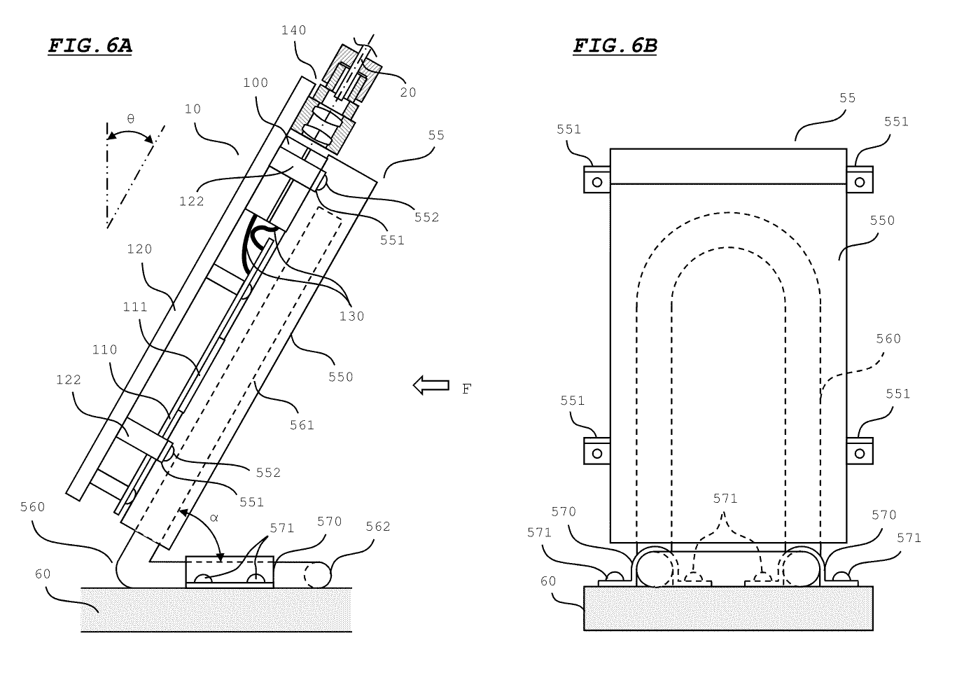

FIGS. 6A and 6B are drawings showing an arrangement of a heat transfer member 55 according to the modification example. FIG. 6A shows a state where a light source portion 10 is mounted on a radiation member 60 through the heat transfer member 55. FIG. 6B is a drawing seeing the heat transfer member 55 from an arrow F direction of FIG. 6A. The light source portion 10 is omitted in FIG. 6B.

The heat transfer member 55 includes endothermic plate 550 and heat pipe 560. The endothermic plate 550 is composed of materials with high thermal conductivity, such as copper, aluminum, etc. The endothermic plate 550 is provided with four flange portions 551. The endothermic plate 550 is fixed on a supporting plate 120 by fastening the flange portion 551 with a screw 552 on a mounting boss.

The heat pipe 560 is composed by bending a pipe formed with a loop shape into a letter L shape between the endothermic portion 561 and the radiation portion 562. The endothermic portion 561 is buried in the endothermic plate 550. The radiation portion 562 is fixed on the radiation member 60 by two mounting metal fittings 570 and screws 571.

A bending angle α of the heat pipe 560 is, as same as the first embodiment above, set according to a tilt angle θ of the optical axis L of the light souse portion 10.

Then, the heat generated at a laser light source 100 and a heat generating component 111 of the light source portion 10 is transmitted to the endothermic portion 561 of the heat pipe 560 through endothermic plate 550, moves to the radiation portion 562 inside the heat pipe 560, arrives at the radiation member 60, and is radiated at the radiation member 60.

As such, if the heat transferring member 55 is arranged using the heat pipe 560, heat generated at the light source portions 10 can be effectively guided to the radiation member60, and therefore, cooling effect of the light source portions 10 can be heightened.

It is noted that, the heat transfer member 55 of this modification example may be substituted by any heat transfer members 50 and 51 of the first or second embodiment.

### Modification Example of Light Source Portions and Holding Structure Therefor

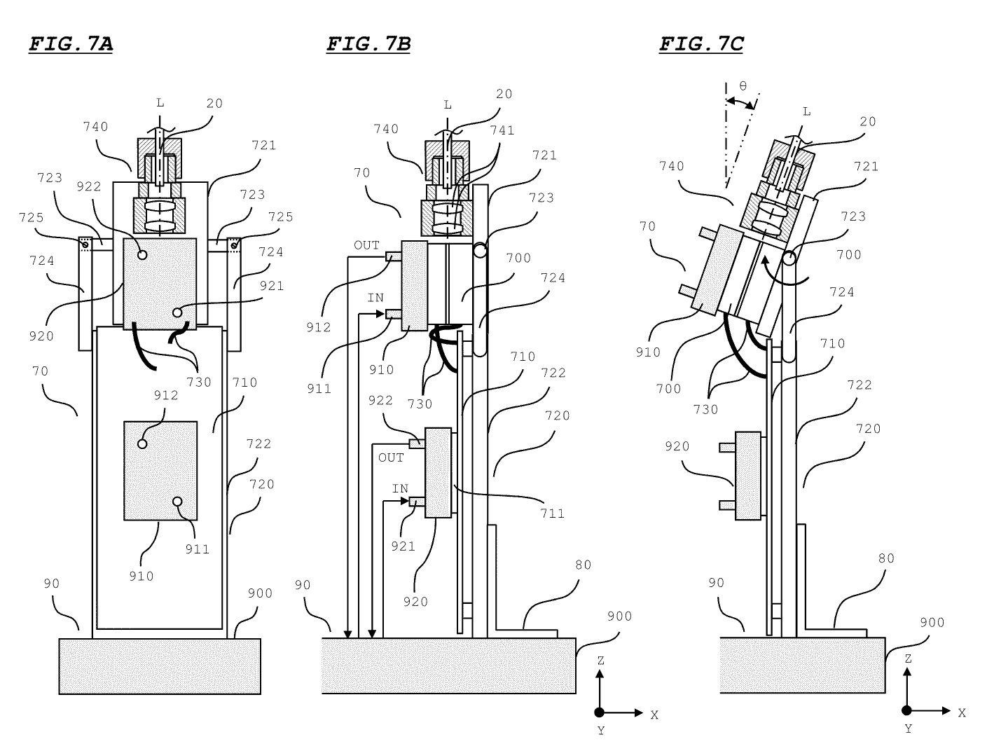

FIGS. 7A, 7B and 7C are drawings showing arrangements and holding structures of the light source portion 70 according to the modification example. FIGS. 7A and 7B are a front view and a side view respectively showing a state before a tilt of an optical axis L of a light source portion 70 is adjusted. FIG. 7C is a side view showing a state after the tilt of the optical axis L of the light source portion 70 is adjusted.

For example, instead of the light source portion 10, heat transfer member 50 and radiation member 60 in the illuminating device of the first embodiment, a structure of this modification can be applied.

The light source portion 70 includes a laser light source 700; a driving circuit substrate 710, a holding plate 720, an electric line 730, and a coupling portion 740. The structure of the laser light source 700, driving circuit substrate 710, electric line 730 and coupling portion 740 is the same as the laser light source 100, driving circuit substrate 110, electric line 130 and coupling portion 140 of the first embodiment. It is noted that, a combination of the laser light source 700 and coupling portion 740 corresponds to the “light source portion” of the present invention.

The holding plate 720 includes a first holding plate 721 on which the laser light source 700 is fixed and a second holding plate 722 on which the driving circuit substrate 710 is fixed.

A pair of shafts 723 is formed on the first holding plate 721. The shafts 723 are supported by a pair of bearing arms 724 provided on the second holding plate 722 so as to be able to rotate freely. Accordingly, the first holding plate 721 is rotatable in an in-plane direction of X-Z plane shown in FIGS. 7B and C.

The laser light source 700 and a heat generating component 711 of the driving circuit substrate 710 are cooled by a cooling unit 90. The cooling unit 90 includes a radiation member 900 and two cooling members 910 and 920. The cooling member 910 is fixed on the top surface of the laser light source 700 by an adhesive, etc. so as to stick firmly, and the cooling member 920 is fixed on the top surface of the heat generating member 711 by an adhesive, etc. so as to stick firmly. A flow channel is formed with a predetermined pattern inside these cooling members 910 and 920.

A flow channel is formed with a predetermined pattern also inside the radiation member 900. A cooling liquid is circulated between the radiation member 900 and the cooling members 910 and 920 as shown by an arrow of FIG. 7B by an operation of a circulation pump which is not illustrated in FIGS. 7A to 7C.

The laser light source 700 and the heat generating component 711 are cooled by heat exchange of a cooling liquid which flows through the cooling members 910 and 920. The cooling liquid warmed by the heat exchange is cooled when passing through the radiation member 900 which is cooled by the air or the like.

The second holding plate 720 is mounted by L-shaped metal fittings 80 on the top surface of the radiation member 900. Accordingly, the light source portion 70 is held by the radiation member 900 in a state being upright.

After the light source portion 70 is mounted on the radiation member 900, as shown in FIG. 7C, for the first holding plate 721 being rotated, a tilt angle θ of an optical axis L of the light source portion 70 is adjusted to be the tilt angle explained in FIG. 1. That is, when the light source portion 70 is used as the leading light source portion 10 shown in FIG. 1A, the optical axis L of the light source portion 70 is set to be the tilt angle of θ1, and when the light source portion 70 is used as the following light source portion 10, the optical axis L of the light source portion 70 is set to be the tilt angle of θ2.

When the tilt angle of the optical axis L of the light source portion 70 is adjusted, the first holding plate 721 is fixed at that state. For example, as a structure for fixing the first holding plate 721, as shown in FIG. 7A, the structure which does not allow the shaft 723 to rotate by pressing the shaft 723 with a tip of a slotted set screw 725 is used. The slotted set screw 725 is tightened from the outside of a bearing arm 724 toward a shaft 723.

As the above, when the arrangement of this modification is used, the tilt angle of the optical axis L of the light source portion 70 can be freely adjusted. Therefore, the optical axis L can be set easily at a desired angle.

It is noted that, in the illuminating device of the second embodiment, the structure of this modification can be applied instead of the light source portion 11, heat transfer member 51 and radiation member 61.

### Embodiment of Projection Display Device

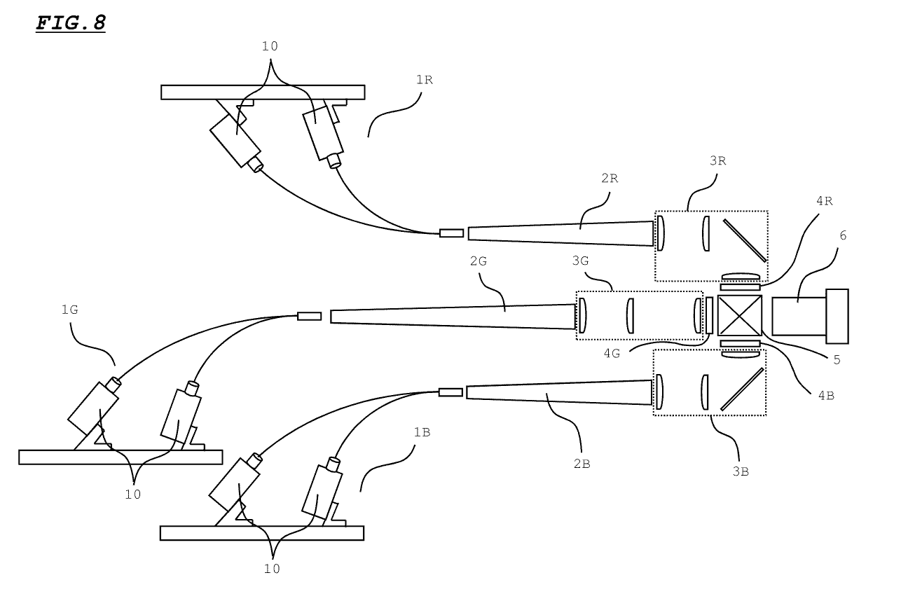

FIG. 8 is a drawing showing an optical system of a projection display device with the illuminating device of the first embodiment.

Three illuminating devices 1R, 1G and 1B comprise the structure described in the first embodiment. The illuminating device 1R includes a plurality of light source portions 10 which emit laser light of red wavelength band (hereinafter, referred to as “R light”). The illuminating device 1G includes a plurality of light source portions 10 which emit laser light of green wavelength band (hereinafter, referred to as “G light”). The illuminating device 1B includes a plurality of light source portions 10 which emit laser light of blue wavelength band (hereinafter, referred to as “B light”).

The R light is emitted from the illuminating device 1R and is incident on a rod integrator 2R. An illumination distribution of the R light is equalized by passing through the rod integrator 2R. After that, the R light is guided to a liquid crystal panel 4R through a relay optical system 3R. Then, the R light is incident on the liquid crystal panel 4R through an incident-side polarizer (not illustrated).

The liquid crystal panel 4R is driven according to an image signal for red light, and modulates the R light according to the driven state thereof. The R light modulated by the liquid crystal panel 4R is incident on a dichroic prism 5 through output-side polarizer (not illustrated).

Similarly, G light is emitted from an illuminating device 1G. The G light is guided to a liquid crystal panel 4G through a rod integrator 2G and a relay optical system 3G, and incident on a liquid crystal panel 4G through the incident-side polarizer (not illustrated). Then, the G light is modulated by the liquid crystal panel 4G and incident on a dichroic prism 5 through the output-side polarizer (not illustrated).

Similarly, B light is emitted from an illuminating device 1B. The B light is guided to a liquid crystal panel 4B through a rod integrator 2B and a relay optical system 3B, and incident on a liquid crystal panel 4B through the incident-side polarizer (not illustrated). Then, the B light is modulated by the liquid crystal panel 4B and incident on a dichroic prism 5 through the output-side polarizer (not illustrated).

The dichroic prism 5 combines the R light, G light and B light which have been modulated by the liquid crystal panels 4R, 4G and 4B, then makes the combined light incident on a projection lens 6. A modulated color image light combined by the dichroic prism 5 is enlarged and projected on a screen by the projection lens 6.

According to a projection display device of the present embodiment, the illuminating device can be miniaturized; therefore the whole device can be miniaturized.

It is noted that, as illuminating devices 1R, 1G and 1B of the above projection display device, the illuminating device of the second embodiment can be applied. Also in this case, the illuminating device can be miniaturized, so the whole device can be miniaturized.

### Other Embodiment of Projection Display Device

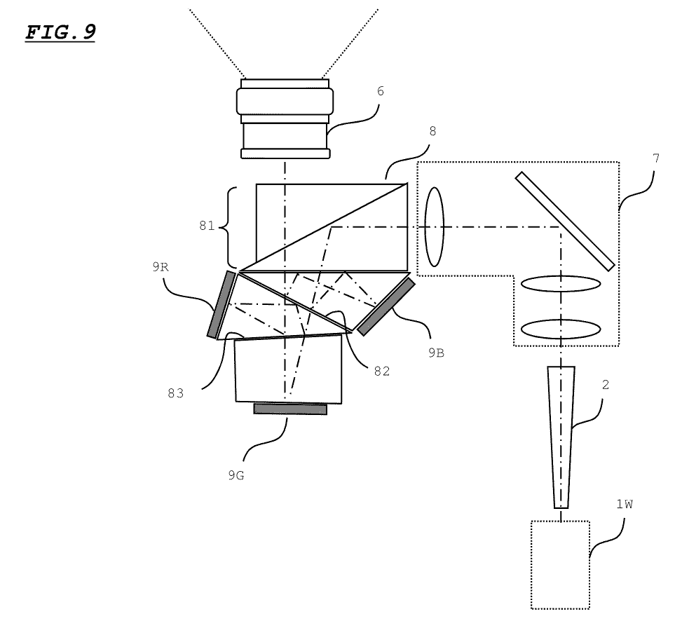

FIG. 9 is a drawing showing the optical system of other projection display device with the illuminating device of the first embodiment.

An illuminating device 1W comprises the structure explained in the first embodiment. The illuminating device 1W includes a plurality of light source portions 10 which emit R light, a plurality of light source portions 10 which emit G light, and a plurality of light source portions 10 which emit B light. Accordingly, white illuminating light, which is a combination of R light, G light and B light, is irradiated from the illuminating device 1W.

An illumination distribution of the illuminating light irradiated from the illuminating device 1W is equalized by a rod integrator 2. After that, the illuminating light passes through a relay optical system 7 comprised with a relay lens and mirror, and is incident on a TIR (Total Internal Reflection) prism 81 of a color separation and recombination prism 8 for 3 DMD (Digital Micro-mirror Device). It is noted that, details of a structure of the color separation and recombination prism 8 for 3DMD is, for example, described in JP2006-79080A. The illuminating light incident on the color separation and recombination prism 8 for 3 DMD is separated by dichroic films 82 and 83 which construct the color separation and recombination prism 8 for 3 DMD. The separated red light is incident on a reflection type display element 9R for R light which is made of the DMD, the separated green light is incident on a display element 9G for G light which is made of the DMD, and the separated blue light is incident on a display element 9B for B light which is made of the DMD. The light paths of these modulated lights, R light, G light and B light, by the display element 9R, 9G and 9B are integrated by the color separation and recombination prism 8 for 3 DMD, and the light made by combining each color light (image light) is incident on the projection lens 6 from the TIR prism 81.

The image light incident on the projection lens 6 is enlarged and projected on a screen.

According to the projection display device of the present embodiment, since the illuminating device can be miniaturized, the whole device can be miniaturized.

It is noted that, as the illuminating device 1W of the above projection display device, the illuminating device of the second embodiment can be applied. Also, in this case, the illuminating device can be miniaturized, so the whole device can be miniaturized.

### Others

In the above first embodiment, the optical fibers 20 are bundled by the support portion 40 before bundled by the bundle 30. However, it is possible that the support portion is eliminated and the optical fibers 20 are bundled only by the bundle 30. In this case, the arcs E1 and E2 shown in FIG. 1A starts from the entrance of the bundle 30, the bundle 30 corresponds to the bundling portion of the present invention.

In addition, the embodiments of the present invention may be modified in various ways, as necessary, as far as such modifications do not depart from the scope of the technical idea of claims of the present invention hereinafter defined.

What is claimed is:

1. An illuminating device comprising:
a plurality of light source portions each having a light source and a condenser optics for condensing light from the light source;
a plurality of optical fibers each connected to a corresponding one of the light source portions and into which the light from the corresponding condenser optics is incident; and
a bundling portion for bundling the plurality of optical fibers, wherein
the plurality of light source portions are arranged on a plane approximately parallel to a bundling-central axis of the bundling portion, and the farther the light source portion is arranged from the bundling portion, the more the optical axis of the condenser optics is tilted toward the bundling portion from a direction vertical to the plane.

2. The illuminating device according to claim 1, comprising:
a radiation member for radiating heat; and
a plurality of heat transfer members each holding the corresponding light source portion to transmit a heat generated by the corresponding light source portion to the radiation member.

3. The illuminating device according to claim 1, comprising:
a first holding member for holding the light source portion; and
a second holding member for holding the first holding member so as to be able to adjust a tilt angle.

4. An illuminating device comprising:
a plurality of light source portions each having a light source and a condenser optics for condensing light from the light source;
a plurality of optical fibers each connected to a corresponding one of the light source portions and into which the light from the corresponding condenser optics is incident; and
a bundling portion for bundling the plurality of optical fibers, wherein
the plurality of light source portions are arranged on a plane approximately vertical to a bundling-central axis of the bundling portion, and the farther the light source portion is arranged from the bundling-central axis of the bundling portion, the more the optical axis of the condenser optics is tilted toward the bundling portion from a direction vertical to the plane.

5. The illuminating device according to claim 4, comprising:
a radiation member for radiating heat; and
a plurality of heat transfer members each holding the corresponding light source portion to transmit a heat generated by the corresponding light source portion to the radiation member.

6. The illuminating device according to claim 4, comprising:
a first holding member for holding the light source portions; and
a second holding member for holding the first holding member so as to be able to adjust a tilt angle.

7. A projection display device comprising:
an illuminating device;
a light modulating portion for modulating light irradiated from the illuminating device; and
a projection portion for projecting the light modulated by the light modulating portion onto a projection plane, wherein
the illuminating device includes:
a plurality of light source portions each having a light source and a condenser optics for condensing light from the light source;
a plurality of optical fibers each connected to a corresponding one of the light source portions and into which the light from the corresponding condenser optics is incident; and
a bundling portion for bundling the plurality of optical fibers, wherein
the plurality of light source portions are arranged on a plane approximately parallel to a bundling-central axis of the bundling portion, and the farther the light source portion is arranged from the bundling portion, the more the optical axis of the condenser optics is tilted toward the bundling portion from a direction vertical to the plane.

8. The projection display device according to claim 7, wherein
the illuminating device comprises:
a radiation member for radiating heat; and
a plurality of heat transfer members each holding the corresponding light source portion to transmit a heat generated by the corresponding light source portion to the radiation member.

9. The projection display device according to claim 7, wherein
the illuminating device comprises:
a first holding member for holding the light source portions; and
a second holding member for holding the first holding member so as to be able to adjust a tilt angle.
